(19) United States
(12) Patent Application Publication
(10) Pub. No.: US 2017/0202059 A1
(43) Pub. Date: Jul. 13, 2017

(54) INDUCTION STIRRING APPARATUS FOR INDUCTION COOKTOPS

(71) Applicant: ELECTROLUX HOME PRODUCTS, INC., CHARLOTTE, NC (US)

(72) Inventors: Paul Stoufer, Lincolnton, NC (US); Thomas Josefsson, Concord, NC (US); John W. Taylor, Cornelius, NC (US); Chris Hoy, Charlotte, NC (US); Stephen Smith, Concord, NC (US)

(21) Appl. No.: 15/404,984

(22) Filed: Jan. 12, 2017

Related U.S. Application Data
(60) Provisional application No. 62/277,876, filed on Jan. 12, 2016.

(51) Int. Cl. H05B 6/12; A23L 5/10; A47J 36/16; F24C 15/10

(52) U.S. Cl. CPC H05B 6/1209; F24C 15/106; A23L 5/10; A47J 36/165; A23V 2002/00

(57) ABSTRACT

An induction stirring apparatus for an apparatus such as a cooktop appliance is provided. The cooking surface is equipped with a transmitter coil, and the induction stirring apparatus comprises a stirring paddle, motor, receiver coil and transformer. The motor is configured to drive a gear to turn the stirring paddle. The receiver coil is inductively coupleable with the transmitter coil of the cooking surface to transfer electrical energy from the transmitter coil to the receiver coil. The transformer is coupled to and between the motor and the receiver coil. The transformer is configured to transfer the electrical energy from the receiver coil to the motor and thereby power the motor to drive the gear.

### CROSS-REFERENCE TO RELATED APPLICATION

The present application claims priority to U.S. Provisional Patent Application No. 62/277,876, entitled: Inductively-Coupled Stirrer Mechanism for Induction Cooktops filed on Jan. 12, 2016, the content of which is incorporated herein by reference.

### TECHNOLOGICAL FIELD

The present disclosure relates generally to appliances and, in particular, to an induction stirring apparatus for a cooktop appliance.

### BACKGROUND

Modern appliances may include appropriate components that provide for controlling and/or operating the appliance. These modern appliances may include, for example, appliances with cooking surfaces such as cooktops (sometimes referred to as a hob). A cooktop refers to a portion of a cooking appliance in which the top surface thereof has one or more heating elements (e.g., burners) installed therein. In some instances, the heating elements are covered by a glass-ceramic panel or other type of cooking surface. In addition, the cooktop includes one or more control elements, each of which is associated with operating a corresponding heating element of the cooktop.

One type of cooktop is an induction cooktop that heat by magnetic induction, instead of by thermal conduction from a flame, or an electrical heating element. A cooking vessel may be positioned over a coil of the induction cooktop, through which an alternating electric current is passed. The alternating current may cause an oscillating magnetic field which induces a magnetic flux that effects heating the cooking vessel. Although the magnetic induction of existing induction cooktops is utilized to heat cooking vessels, it may be generally desirable to provide other uses for the magnetic induction thereof.

### BRIEF SUMMARY

Example implementations of the present disclosure are directed to an improved stirring apparatus for use with induction cooktops. In some example implementations, an induction stirring apparatus is provided for a cooking surface equipped with a transmitter coil. The induction stirring apparatus comprises a stirring paddle, a motor configured to drive a gear to turn the stirring paddle, and a receiver coil inductively coupleable with the transmitter coil of the cooking surface to transfer electrical energy from the transmitter coil to the receiver coil. The induction stirring apparatus also comprises a transformer coupled to and between the motor and receiver coil and configured to transfer the electrical energy from the receiver coil to the motor and thereby power the motor to drive the gear.

In some example implementations of the induction stirring apparatus of the preceding or any subsequent example implementation, or any combination thereof, the motor is configured to drive the gear to turn the stirring paddle in a substance contained in a vessel supported by the cooking surface. The stirring paddle is structured to support a viscosity of the substance. In some example implementations of the induction stirring apparatus of any preceding or any subsequent example implementation, or any combination thereof, the cooking surface is an induction cooking surface, and the transmitter coil is also inductively coupleable with the vessel to transfer electrical energy from the transmitter coil to the vessel and thereby heat the vessel and substance contained therein.

In some example implementations of the induction stirring apparatus of any preceding or any subsequent example implementation, or any combination thereof, the cooking surface is an induction cooking surface equipped with another coil that is separate and distinct from the transmitter coil. The other coil is inductively coupleable with the vessel to transfer electrical energy from the other coil to the vessel and thereby heat the vessel and substance contained therein.

In some example implementations of the induction stirring apparatus of any preceding or any subsequent example implementation, or any combination thereof, the motor is a direct current (DC) motor, and the induction stirring apparatus further comprises a power converter coupled to and between the transformer and DC motor. The power converter is configured to convert the electrical energy from the transformer into a DC voltage to power the DC motor.

In some example implementations of the induction stirring apparatus of any preceding or any subsequent example implementation, or any combination thereof, the transformer comprises a primary winding and a secondary winding about a ferrite core

In some example implementations of the induction stirring apparatus of any preceding or any subsequent example implementation, or any combination thereof, an outer turn of the receiver coil is coupled with an inner turn of the receiver coil via a magnetic wire that is further wound about the ferrite core to form the primary winding.

In some example implementations, method of operating an induction stirring apparatus for a cooking surface equipped with a transmitter coil is provided. The induction stirring apparatus includes a receiver coil, a transformer coupled to and between the receiver coil, and a motor configured to drive a gear to turn a stirring paddle. The method comprises receiving, at the receiver coil, electrical energy from the transmitter coil of the cooking surface. The receiver coil is inductively coupled to the transmitter coil. The method also comprises transferring, via the transformer, the electrical energy from the receiver coil to the motor and thereby powering the motor to drive the gear. The method also comprises driving, using the motor, the gear to turn the stirring paddle.

In some example implementations of the method of the preceding or any subsequent example implementation, or any combination thereof, driving the gear to turn the stirring paddle includes driving the gear to turn the stirring paddle in a substance contained in a vessel supported by the cooking surface. The stirring paddle is structured to support a viscosity of the substance.

In some example implementations of the method of any preceding or any subsequent example implementation, or any combination thereof, the cooking surface is an induction cooking surface, and the transmitter coil is also inductively coupleable with the vessel, and the method further comprises transferring electrical energy from the transmitter coil to the vessel and thereby heating the vessel and substance contained therein.

In some example implementations of the method of any preceding or any subsequent example implementation, or any combination thereof, the cooking surface is an induction cooking surface equipped with another coil that is separate and distinct from the transmitter coil. The other coil is inductively coupleable with the vessel, and the method further comprises transferring electrical energy from the other coil to the vessel and thereby heating the vessel and substance contained therein.

In some example implementations of the method of any preceding or any subsequent example implementation, or any combination thereof, the motor is a direct current (DC) motor, and the method further comprises converting, using a power converter, the electrical energy from the transformer into a DC voltage. The method also further comprises powering the motor using the DC voltage, the power converter being coupled to and between the transformer and DC motor.

In some example implementations of the method of any preceding or any subsequent example implementation, or any combination thereof, the transformer comprises a primary winding and a secondary winding about a ferrite core.

In some example implementations of the method of any preceding or any subsequent example implementation, or any combination thereof, an outer turn of the receiver coil is coupled with an inner turn of the receiver coil via a magnetic wire that is further wound about the ferrite core to form the primary winding.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure, regardless of whether such features or elements are expressly combined or otherwise recited in a specific implementation description herein. This disclosure is intended to be read holistically such that any separable features or elements of the disclosure, in any of its aspects and implementations, should be viewed as intended, namely to be combinable, unless the context of the disclosure clearly dictates otherwise.

It will therefore be appreciated that the above Summary is provided merely for purposes of summarizing some example implementations so as to provide a basic understanding of some aspects of the disclosure. As such, it will be appreciated that the above described example implementations are merely examples of some implementations and should not be construed to narrow the scope or spirit of the disclosure in any way. It will be appreciated that the scope of the disclosure encompasses many potential implementations, some of which will be further described below, in addition to those here summarized. Further, other aspects and advantages of implementations disclosed herein will become apparent from the following detailed description taken in conjunction with the accompanying drawings which illustrate, by way of example, the principles of the described implementations.

### BRIEF DESCRIPTION OF THE DRAWING(S)

Having thus described example implementations of the disclosure in general terms, reference will now be made to the accompanying drawings, which are not necessarily drawn to scale, and wherein:

FIG. 1 is a schematic block diagram of a cooktop appliance according to example implementations of the present disclosure;

FIG. 2 illustrates an induction stirring apparatus, according to example implementations of the present disclosure; and

FIG. 3 is a circuit level schematic of the cooktop appliance and induction stirring apparatus of respectively FIG. 1 and FIG. 2, according to example implementations of the present disclosure.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. For example, unless otherwise indicated, reference something as being a first, second or the like should not be construed to imply a particular order. Like reference numerals refer to like elements throughout. Also, for example, reference may be made herein to quantitative measures, values, relationships or the like. Unless otherwise stated, any one or more if not all of these may be absolute or approximate to account for acceptable variations that may occur, such as those due to engineering tolerances or the like.

Example implementations of the present disclosure are generally directed to an induction stirring apparatus or mechanism for a cooking surface equipped with a transmitter coil, such as an induction cooking surface configured to heat a substance such as a food product through an induction process. The induction stirring apparatus may be configured to simultaneously stir the food product being heated. In accordance with example implementations, the induction stirring apparatus may harvest power from the cooking surface which may remove the need of a battery to supply power thereto. The induction stirring apparatus may be suitable for any of a number of different apparatuses including any of a number of different cooktop appliances.

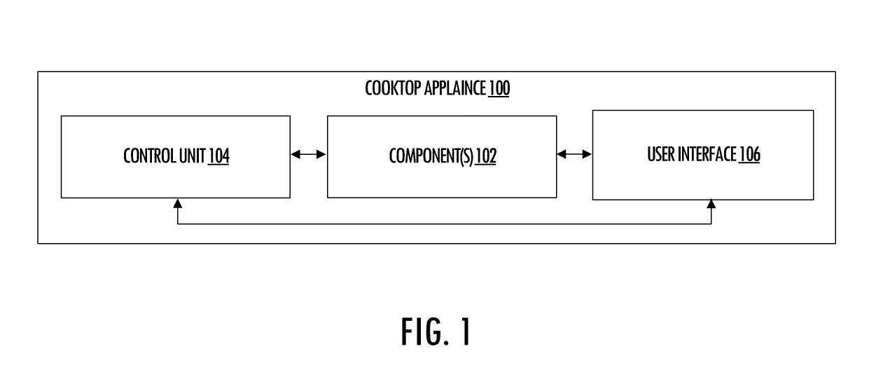

FIG. 1 illustrates a cooktop appliance 100 according to example implementations of the present disclosure. The cooktop appliance may be any of a number of different types of induction cooktops, ranges or food warmers. As shown, the cooktop appliance 100 may include a plurality of components 102 generally configured to perform cooking such as heating elements and the like. As discussed herein, an induction cooktop appliance may refer to a cooking appliance for inductively heating a cooking vessel, as described in U.S. Pat. No. 3,814,888 to Bowers et al. which is incorporated herein by reference. The components of an induction cooktop appliance may include an induction heating coil mounted beneath a cooking surface on which the cooking vessel may be placed. The induction heating coil is driven with an ultrasonic frequency wave generated by a static power conversion circuit typically formed of a rectifier and an inverter.

According to example implementations, at least some components 102 of the cooktop appliance may be configured to operate under direct control of a control unit 104 and/or a user interface 106. While the user interface may effect direct control of the components, the user interface 106 may, in some implementations, be further coupled to the control unit and also configured to operate under control of the control unit to thereby effect control of the components. The control unit includes a number of electronic components such as a microprocessor or processor core, and a memory. In some examples, the control unit may include a microcontroller with integrated processor core and memory, and may further include one or more integrated input/output peripherals. The user interface 106 may receive user input and in some examples provide an audible, visual, mechanical, or other output to a user. The user interface may include a control knob, joystick, keypad, keyboard, display, touch screen display, microphone, speaker, biometric input device, and/or other input/output mechanism.

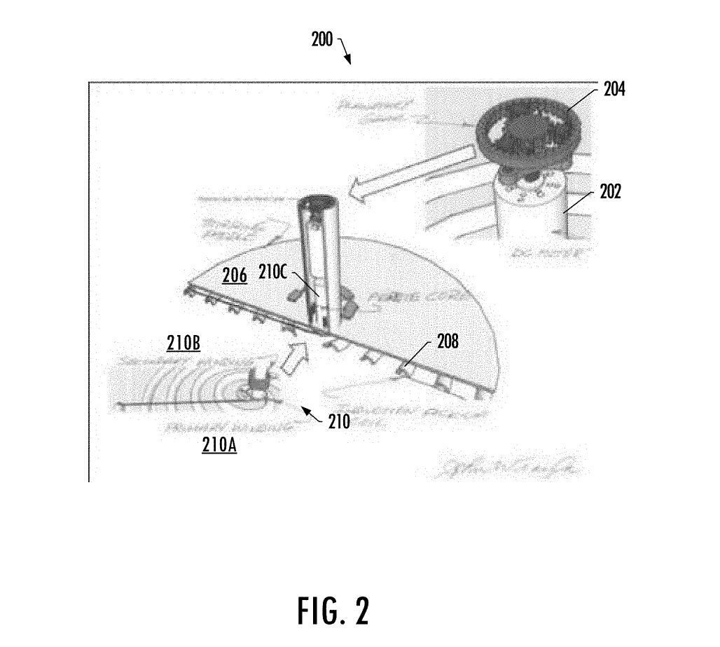

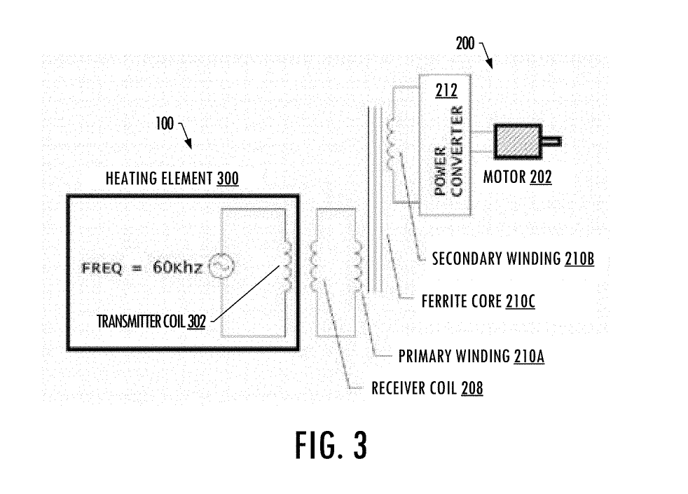

FIG. 2 illustrates an induction stirring apparatus 200 that may be utilized in conjunction with the cooktop appliance 100 of FIG. 1, according to some example implementations of the present disclosure. FIG. 3 illustrates a circuit level schematic of the induction stirring apparatus according to example implementations. It should be noted that FIG. 2 illustrates only one example implementation of the circuit and the induction stirring apparatus may be implemented using various circuit configurations. As shown in FIG. 2, the induction stirring apparatus may include a motor 202, gear 204, paddle 206, receiver coil 208, transformer 210 and power converter 212. As shown in FIG. 3, the induction stirring apparatus may be operatively coupled to a cooking surface and/or heating element 300 equipped with a transmitter coil 302, which in some examples may correspond to components 102 of the appliance 100 of FIG. 1. In some examples, the transmitter coil may be the induction heating coil of the cooktop appliance, or rather the induction heating coil may also function as the transmitter coil. In other examples, the transmitter coil may be separate and distinct from the induction heating coil.

The various components of the induction stirring apparatus 200 may each be configured to implement respective functions for stirring a substance such as a food product. The motor 202 may be configured to drive the gear 204 (e.g., a planetary gear) to turn the stirring paddle 206. The receiver coil 208 may be inductively coupleable with the transmitter coil 302 of the cooking surface 300 to transfer electrical energy from the transmitter coil to the receiver coil. In one example implementation, the receiver coil may be or include an induction pickup coil that may be placed above the cooking surface. The transformer may be coupled to and between the motor and the receiver coil. The transformer may be configured to transfer the electrical energy from the receiver coil to the motor and thereby power the motor to drive the gear.

As shown in FIGS. 2 and 3, the transformer 210 may comprise a primary winding 210A and a secondary winding 210B about a ferrite core 210C (e.g., a round ferrite core). In some implementations, an outer turn of the receiver coil 208 may be coupled with an inner turn of the receiver coil via a magnetic wire. The magnetic wire may then be further wound about the ferrite core to form the primary winding. The magnetic wire, and more particularly the primary winding, may be wound about the ferrite core with one or two turns. The secondary winding may be or include a multiple turn winding about the ferrite core just above the one or two turn primary winding. The power generated by the output of the secondary winding may then be converted to a voltage and applied to the motor 202.

In some implementations, the motor is a direct current (DC) motor, and the induction stirring apparatus 200 include a power converter 212 coupled to and between the transformer 210 and the DC motor. The power converter may be configured to convert the electrical energy from the transformer into a DC voltage to power the DC motor. The motor may comprise an output shaft operatively coupled to the gear 204 and configured to produce a torque to drive the gear to turn the stirring paddle 206. That is, the output shaft of the motor may be connected to the gear to produce enough torque to turn the stirring paddle for thereby stirring a substance (e.g., a food product).

In some examples, the motor 202 may be configured to drive the gear 204 to turn the stirring paddle in a substance contained in a vessel supported by the cooking surface and/or heating element 300. In these examples, the stirring paddle may be structured to support a viscosity of the substance. In some examples, the stirring paddle may be structured such that various stirring paddle configurations may be well suited to handle different viscosities of the substance. The vessel supported by the cooking surface may be or include a non-ferrous pan such as glass or aluminum in which the receiver coil 208 may be positioned within a base of the vessel.

Further in these examples, the heating element 300 may be an induction cooking surface (e.g., an induction cooktop surface), and the transmitter coil 302 may also be inductively coupleable with the vessel to transfer electrical energy from the transmitter coil to the vessel and thereby heat the vessel and substance contained therein. In some examples, the cooking surface may also be equipped with another coil that is separate and distinct from the transmitter coil. In these examples, the other coil may be inductively coupleable with the vessel to transfer electrical energy from the other coil to the vessel and thereby heat the vessel and substance contained therein while the transmitter coil may only be inductively coupleable with the receiver coil 208 to transfer electrical energy thereto.

Many modifications and other implementations of the disclosure set forth herein will come to mind to one skilled in the art to which these disclosure pertain having the benefit of the teachings presented in the foregoing descriptions and the associated drawings. Therefore, it is to be understood that the disclosure are not to be limited to the specific implementations disclosed and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An induction stirring apparatus for a cooking surface equipped with a transmitter coil, the induction stirring apparatus comprising:
a stirring paddle;
a motor configured to drive a gear to turn the stirring paddle;
a receiver coil inductively coupleable with the transmitter coil of the cooking surface to transfer electrical energy from the transmitter coil to the receiver coil; and
a transformer coupled to and between the motor and receiver coil, the transformer being configured to transfer the electrical energy from the receiver coil to the motor and thereby power the motor to drive the gear.

2. The induction stirring apparatus of claim 1, wherein the motor is configured to drive the gear to turn the stirring paddle in a substance contained in a vessel supported by the cooking surface, the stirring paddle being structured to support a viscosity of the substance.

3. The induction stirring apparatus of claim 2, wherein the cooking surface is an induction cooking surface, and the transmitter coil is also inductively coupleable with the vessel to transfer electrical energy from the transmitter coil to the vessel and thereby heat the vessel and substance contained therein.

4. The induction stirring apparatus of claim 2, wherein the cooking surface is an induction cooking surface equipped with another coil that is separate and distinct from the transmitter coil, the other coil being inductively coupleable with the vessel to transfer electrical energy from the other coil to the vessel and thereby heat the vessel and substance contained therein.

5. The induction stirring apparatus of claim 1, wherein the motor is a direct current (DC) motor, and the induction stirring apparatus further comprises a power converter coupled to and between the transformer and DC motor, the power converter being configured to convert the electrical energy from the transformer into a DC voltage to power the DC motor.

6. The induction stirring apparatus of claim 1, wherein the transformer comprises a primary winding and a secondary winding about a ferrite core.

7. The induction stirring apparatus of claim 6, wherein an outer turn of the receiver coil is coupled with an inner turn of the receiver coil via a magnetic wire that is further wound about the ferrite core to form the primary winding.

8. A method of operating an induction stirring apparatus for a cooking surface equipped with a transmitter coil, the induction stirring apparatus including a receiver coil, and a transformer coupled to and between the receiver coil and a motor configured to drive a gear to turn a stirring paddle, the method comprising at the induction stirring apparatus:
receiving, at the receiver coil, electrical energy from the transmitter coil of the cooking surface, the receiver coil being inductively coupled to the transmitter coil;
transferring, via the transformer, the electrical energy from the receiver coil to the motor and thereby powering the motor to drive the gear; and
driving, using the motor, the gear to turn the stirring paddle.

9. The method of claim 8, wherein driving the gear to turn the stirring paddle includes driving the gear to turn the stirring paddle in a substance contained in a vessel supported by the cooking surface, the stirring paddle being structured to support a viscosity of the substance.

10. The method of claim 9, wherein the cooking surface is an induction cooking surface, and the transmitter coil is also inductively coupleable with the vessel, and
wherein the method further comprises transferring electrical energy from the transmitter coil to the vessel and thereby heating the vessel and substance contained therein.

11. The method of claim 9, wherein the cooking surface is an induction cooking surface equipped with another coil that is separate and distinct from the transmitter coil, the other coil being inductively coupleable with the vessel, and the method further comprises transferring electrical energy from the other coil to the vessel and thereby heating the vessel and substance contained therein.

12. The method of claim 8, wherein the motor is a direct current (DC) motor, and the method further comprises:
converting, using a power converter, the electrical energy from the transformer into a DC voltage; and
powering the motor using the DC voltage, the power converter being coupled to and between the transformer and DC motor.

13. The method of claim 8, wherein the transformer comprises a primary winding and a secondary winding about a ferrite core.

14. The method of claim 13, wherein an outer turn of the receiver coil is coupled with an inner turn of the receiver coil via a magnetic wire that is further wound about the ferrite core to form the primary winding.
